(19) United States
(12) Patent Application Publication
(10) Pub. No.: US 2012/0216690 A1
(43) Pub. Date: Aug. 30, 2012

(54) MASK FOR SCREEN PRINTING, SCREEN PRINTING DEVICE AND SCREEN PRINTING METHOD EMPLOYING SAME

(75) Inventors: Michinori Tomomatsu, Yamanashi (JP); Masanori Ikeda, Yamanashi (JP); Masahiro Taniguchi, Yamanashi (JP); Satoshi Furuichi, Yamanashi (JP)

(73) Assignee: Panasonic Corporation, Osaka (JP)

(21) Appl. No.: 13/508,055

(22) PCT Filed: Oct. 7, 2010
(86) PCT No.: PCT/JP2010/006003

§ 371 Date: May 4, 2012

(30) Foreign Application Priority Data
Nov. 6, 2009 (JP) 2009254655

(51) Int. Cl. B05C 17/06

(52) U.S. Cl. 101/123; 101/127; 101/129

(57) ABSTRACT

The screen printing mask is used for printing paste simultaneously on circuit boards held by the carrier. The mask has a flat mask plate. On the lower surface of the mask plate, a flat-bottomed recess capable to accommodating at least one of the circuit boards is formed so as to correspond to the array of the circuit boards on the carrier. A pattern hole is formed only in the recess.

### TECHNICAL FIELD

The present invention relates to a screen printing mask used in printing paste for connecting electronic components onto circuit boards held by a carrier. The present invention also relates to a screen printing device and a screen printing method employing the mask.

### BACKGROUND ART

A thin film circuit board, such as a flexible printed circuit board on which electronic components are mounted, has difficulty in handling. For easy handling, such a circuit board is handled in a manner that circuit boards are fixed on or are held by a plate-like carrier. That is, while being held by a carrier, the circuit boards undergo printing of paste for connecting electronic components and component mounting work (for example, see patent literatures 1 through 4).

In the examples of patent literatures 1 and 2, the carrier has an adhesive surface formed of silicone elastomer or the like so that the circuit boards are held by the adhesion of the surface. In the examples of patent literatures 3 and 4, the carrier has a recess that conforms to the flat shape of the circuit board and accommodates it therein. In the examples above, the circuit boards on the carrier similarly undergo paste printing. That is, the upper surface, on which the circuit boards are mounted, of the carrier makes contact with a screen printing mask and a squeegee slides on the mask for printing paste on the circuit boards.

The methods above, however, have some problems in achieving high printing quality and low production cost. First, the examples of patent literatures 1 and 2 are described with reference to FIGS. 10A and 10B. FIGS. 10A and 10B illustrate squeegee operation using a conventional mask for screen printing.

In FIG. 10A, thin film circuit board 32A is held by adhesion on the upper surface of carrier 31. Circuit board 32A makes contact with the lower surface of mask 33. In the squeegee operation, squeegee 34 is lowered to the upper surface of mask 33 so as to slide on mask 33 with a predetermined pressure on mask 33. Between the upper surfaces of circuit board 32A and carrier 31, there is a difference in height by the thickness of circuit board 32A. Therefore, mask 33 may not be attached firmly to the surface to be printed on circuit board 32A and partly lifted in a rippling shape in the both edges of circuit board 32A, thereby a clearance can be generated between mask 33 and the surface to be printed on circuit board 32A. In the area with a clearance caused by poor contact, the paste cannot be properly printed on the surface so that the phenomenon causes printing failure. Further, when the paste is printed on circuit board 32B of narrow width, as shown in FIG. 10B, mask 33 is heaved up over the width of circuit board 32B, therefore normal printing cannot be performed. The methods of patent literatures 1 and 2 can invite printing failure caused by the structure where circuit boards 32A and 32B are fixed directly on carrier 31 of a flat shape.

The methods shown in patent literatures 3 and 4 have need for preparing carriers suitable in number for each production lot. Besides, the shape of the recess depends on the type of a circuit board; that is, each time a circuit board of a new type is handled, many carriers have to be formed so as to fit with the new circuit board. The recess has to be formed with high accuracy in shape and size on the carrier. These necessities have increased cost of preparing a carrier with recesses, and accordingly, hampered reduction of production cost.

As described above, for printing the paste for connecting electronic components simultaneously on circuit boards held by a carrier, a conventional screen printing device has difficulty in achieving high printing quality at a low cost.

### CITATION LIST

### Patent Literature

### PTL 1: Japanese Unexamined Patent Application Publication No. 63-204696

### PTL 2: Japanese Unexamined Patent Application Publication No. 2003-273592

### PTL 3: Japanese Unexamined Patent Application Publication No. 63-299300

### PTL 4: Japanese Unexamined Patent Application Publication No. 08-264996

### SUMMARY OF THE INVENTION

The present invention provides a mask for screen printing, a screen printing device and a method of screen printing employing the mask. With the structure of the present invention, circuit boards held by a carrier undergoes screen printing with high printing quality at a low cost.

The screen printing device of the present invention is used for simultaneously printing paste, which is to be used for connecting electronic components to circuit boards, on an electrode formed on each of the circuit boards arrayed and held by a carrier. The screen printing device has a printing mechanism and a carrier positioning section. The printing mechanism includes a single mask for screen printing and a squeegee member. In squeegee operation, the squeegee member slides on the paste-applied upper surface of the mask so that the paste is printed on an electrode. The mask has a flat mask plate that covers the area in which the circuit boards are arrayed on the carrier. The carrier positioning section determines the position of the carrier so that the circuit boards are properly positioned to the mask. On the lower surface of the mask plate, a recess is formed so as to correspond to the array of the circuit boards. Having a flat part, the recess accommodates at least one of the circuit boards. A pattern hole corresponding to the electrode is formed only in the recess.

The mask for screen printing of the present invention is that employed in the screen printing device described above.

The screen printing method of the present invention is for simultaneously printing paste, which is to be used for connecting electronic components to circuit boards, with use of the aforementioned mask, to an electrode formed on each of the circuit board arrayed and held by a carrier. The screen printing method has a positioning step, a touching step, a printing step, and a releasing step. In the positioning step, the screen printing mask is positioned properly with respect to the circuit boards held by the carrier. In the touching step, the mask positioned in the positioning step is set so as to make contact with the upper surface of the carrier and the upper surfaces of the circuit boards held by the carrier. In the printing step, the squeegee operation is carried out. That is, while the mask is making contact with the upper surface of the carrier and the upper surface of each circuit board, the squeegee member slides on the upper surface of the mask to fill a pattern hole with the paste supplied on the mask. In the releasing step, the mask is released from the carrier and the circuit boards.

According to the present invention, a recess is formed so as to correspond to the array of the circuit boards on the lower surface of the flat mask plate of the mask. Having a flat part, the recess is capable of accommodate at least one of the circuit boards. A pattern hole is formed only in the recess. The structure above allows the carrier to have a flat holding surface with a simple structure, preventing printing failure. As a result, a plurality of circuit boards held by the carrier undergoes printing operation with high printing quality at a low cost.

### BRIEF DESCRIPTION OF THE DRAWINGS

FIG. 1 is a perspective view showing a screen printing device in accordance with an exemplary embodiment of the present invention.

FIG. 2 is a perspective view showing a carrier used with the screen printing device shown in FIG. 1.

FIG. 3 is a plan view of the carrier shown in FIG. 2.

FIG. 4 is a perspective plan view of a mask for screen printing used for the screen printing device shown in FIG. 1.

FIG. 5A shows an operating state in screen printing by the screen printing device shown in FIG. 1.

FIG. 5B shows an operating state that follows the state of FIG. 5A.

FIG. 5C shows an operating state that follows the state of FIG. 5B.

FIG. 5D shows an operating state that follows the state of FIG. 5C.

FIG. 6A shows an operating state in screen printing by another screen printing device of the exemplary embodiment of the present invention.

FIG. 6B shows an operating state that follows the state of FIG. 6A.

FIG. 6C shows an operating state that follows the state of FIG. 6B.

FIG. 6D shows an operating state that follows the state of FIG. 6C.

FIG. 7A shows a sectional view of a screen printing mask, where the mask is divided into components, employed for the screen printing device shown in FIGS. 6A through 6D.

FIG. 7B shows a sectional view of the screen printing mask employed for the screen printing device shown in FIGS. 6A through 6D.

FIG. 8A shows a sectional view of another mask for screen printing, where the mask is divided into components, employed for the screen printing device of the exemplary embodiment of the present invention.

FIG. 8B shows a sectional view of another mask for screen printing employed for the screen printing device of the exemplary embodiment of the present invention.

FIG. 9 is a perspective plan view of still another mask for screen printing employed for the screen printing device of the exemplary embodiment of the present invention.

FIG. 10A illustrates a squeegee operation with use of a conventional screen printing mask.

FIG. 10B illustrates a squeegee operation with use of a conventional screen printing mask.

### DETAILED DESCRIPTION OF THE PREFERRED EMBODIMENTS

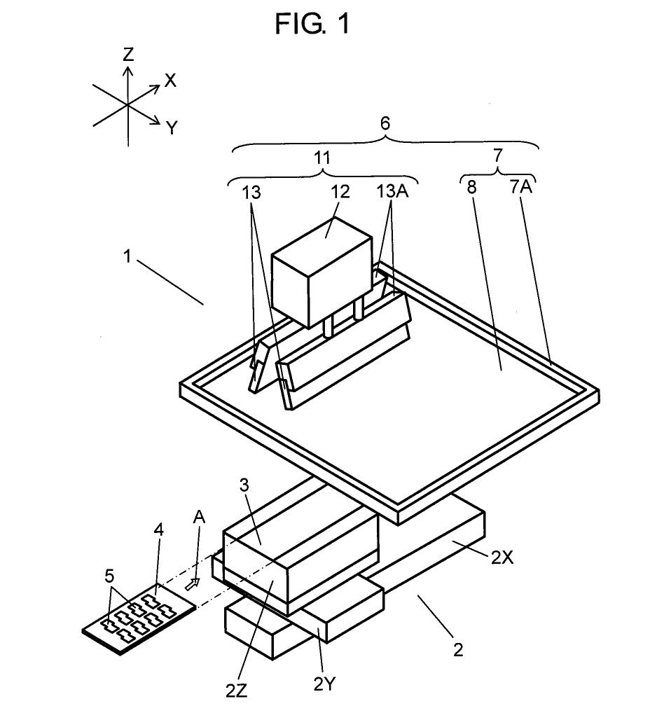

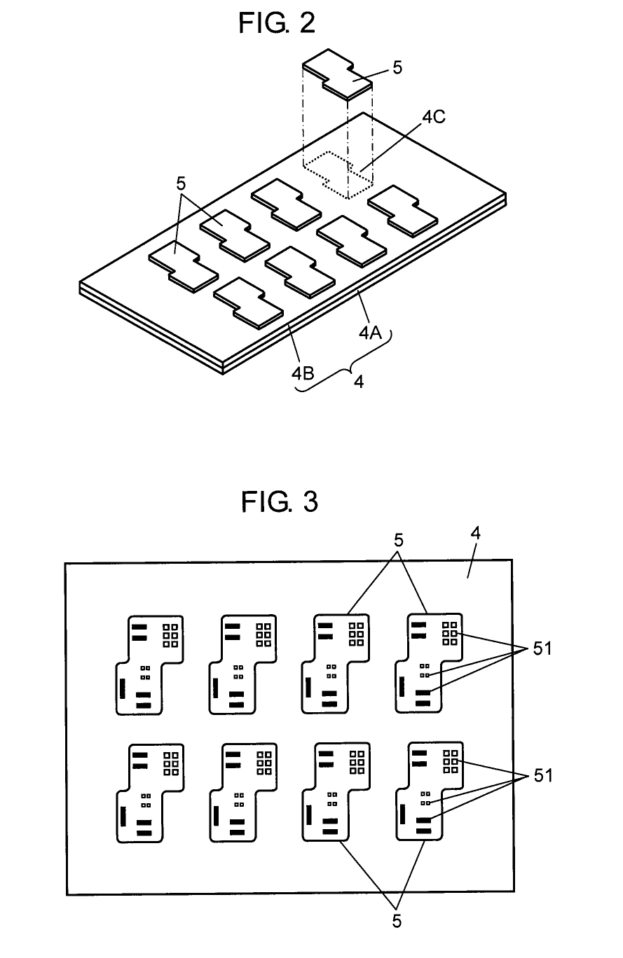

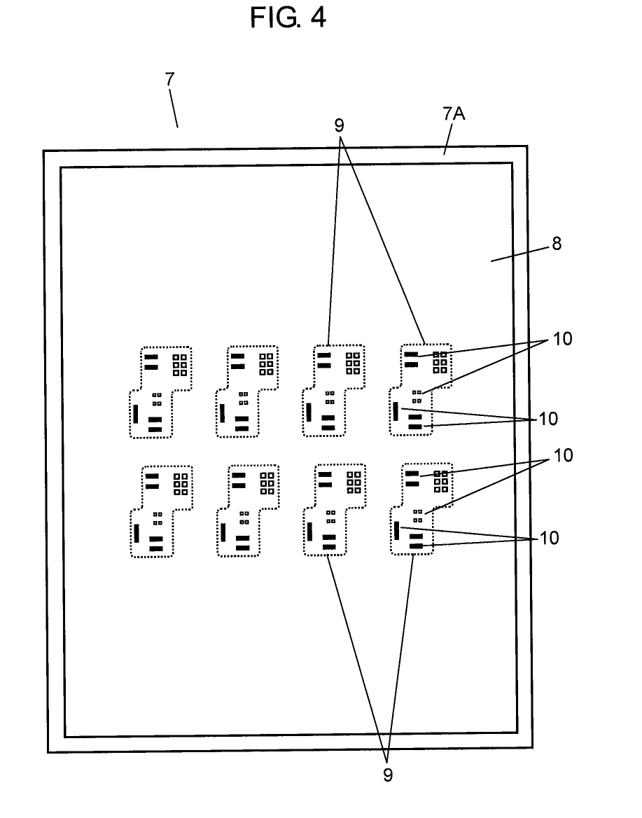

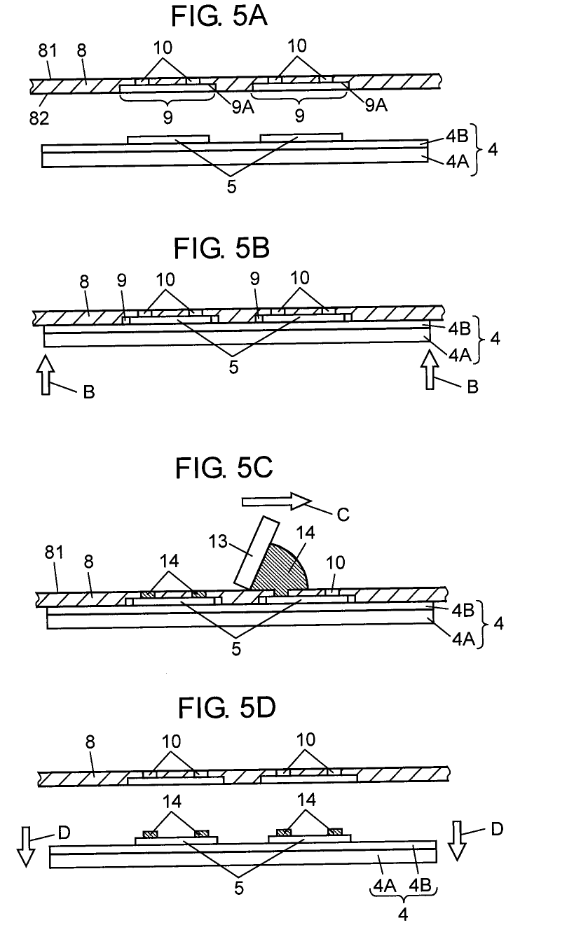

FIG. 1 is a perspective view showing a screen printing device in accordance with an exemplary embodiment of the present invention. FIG. 2 is a perspective view showing a carrier used with the screen printing device shown in FIG. 1. FIG. 3 is a plan view of the carrier shown in FIG. 2. FIG. 4 is a perspective plan view of a mask for screen printing used for the screen printing device shown in FIG. 1. FIGS. 5A through 5D illustrate the printing operation by the screen printing device shown in FIG. 1.

First, the structure of screen printing device 1 is described with reference to FIG. 1 and FIG. 3. Circuit boards 5 are fixed on or held by carrier 4. Screen printing device 1 prints paste, which is to be used for connecting electronic components to circuit board 5, simultaneously on electrode 51 formed on each of circuit boards 5.

Screen printing device 1 has printing mechanism 6 including screen printing mask 7 disposed over carrier positioning section 2. That is, screen printing device 1 has carrier positioning section 2 and printing mechanism 6 including single mask 7. Mask 7 has flat mask plate 8 that covers the area in which circuit boards 5 are disposed on carrier 4. Carrier positioning section 2 determines the position of carrier 4 so that circuit boards 5 are properly positioned to mask 7. Printing mechanism 6 further includes squeegee member 13. In squeegee operation, squeegee member 13 slides on the paste-applied upper surface of mask 7, so that the paste is printed on electrode 51 of circuit board 5 on carrier positioning section 2 (that will be described later).

Mask 7 has rectangular mask frame 7A and mask plate 8 formed inside mask frame 7A.

Carrier positioning section 2 has a structure of X-axis table 2X, Y-axis table 2Y, and Zθ-axis table 2Z layered from the bottom in the order named. The upper surface of Zθ-axis table 2Z is carrier mounting surface 3 for mounting carrier 4 which holds circuit boards 5 to be printed thereon. Carrier 4 is fed automatically or manually from the upstream (as shown by arrow A) by a carrier mechanism (not shown) and mounted on and held by carrier mounting surface 3.

In printing mechanism 6, a squeegee moving mechanism moves squeegee head 11 back and forth in a direction of squeegee operation (i.e., in the Y-axis direction) on mask plate 8 of mask 7. Squeegee head 11 has holder 13A, a pair of squeegee members 13 held by holder 13A, and squeegee elevating mechanism 12 for moving up and down squeegee member 13. When squeegee member 13 is moved to the lowest position, the edge of squeegee member 13 makes contact with the upper surface of mask plate 8.

Next, the structures of carrier 4 and circuit board 5 will be described with reference to FIG. 2 and FIG. 3. As shown in FIG. 2, carrier 4 has a structure in which resin layer 4B is laminated on rectangular base plate 4A. Base plate 4A is made of metal such as aluminum, a resin with heat resistance or ceramics. Base plate 4 enhances rigidity of carrier 4. Resin layer 4B is formed of a resin having adhesion, such as silicone resin. Circuit board 5 is pressed on the flat and smooth upper surface of resin layer 4B so as to be tightly held by resin layer 4B.

Circuit board fixing positions 4C are arranged on carrier 4 for fixing circuit boards 5. While being held by carrier 4, circuit boards 5 undergo screen printing, which will be described later. As is shown in FIG. 3, electrodes 51 for connecting components to circuit board 5 are formed on circuit board 5.

As shown in FIG. 4 and FIG. 5A, mask 7 has single mask plate 8 that covers the area in which circuit boards 5 are arrayed, and rectangular mask frame 7A. Recesses 9 are formed by etching lower surface 82 of mask plate 8 so as to correspond to the arrayed positions of circuit boards 5. Each of recesses 9 is capable of accommodating respective one of circuit boards 5. That is, the flat bottom and the depth of recess 9 are determined so as to conform to the external size and the thickness, respectively, of circuit board 5. In addition, pattern holes 10 are formed in each of recesses 9 on mask plate 8 so as to correspond to the positions of electrodes 51 of circuit board 5. As shown in FIG. 5A, it is preferable that bottom 9A of each of recesses 9 should be flat. Furthermore, it is preferable that bottom 9A should touch with the upper surface of circuit board 5 in the printing step (which will be described later). Upper surface 81 of mask plate 8 is formed to be flat and smooth.

Next, the screen printing operation on circuit boards 5 by screen printing device 1 will be described with reference to FIGS. 5A through 5D. As shown in FIG. 5A, each circuit board 5 is tightly held by adhesion force of the upper surface of resin layer 4B at respective one of circuit board fixing positions 4C (see FIG. 2) formed on the upper surface of adhesive resin layer 4B of carrier 4. With the condition above maintained, carrier 4 is positioned by carrier positioning section 2 so as to have a proper position with respect to mask 7, which allows circuit boards 5 to be positioned with respect to recesses 9 on mask plate 8. That is, in the positioning step, carrier positioning section 2 positions carrier 4 so that each recess 9 covers each circuit board 5 and carrier positioning section 2 positions circuit boards 5 with respect to mask 7.

In the next touching step, as shown in FIG. 5B, carrier 4 is moved up (in the direction of arrow B) by driving Zθ-axis table 2Z so that resin layer 4B contacts with lower surface 82 of mask plate 8. Through the process above, circuit boards 5 is accommodated in recess 9 and electrodes 51 (see FIG. 3) to be printed thereon are located underneath corresponding pattern holes 10. At this time, it is preferable that only flat bottom 9A of recess 9 contacts to the upper surface of circuit board 5 held by carrier 4. In this case, lower surface 82 of mask plate 8 except for recesses 9 makes contact with the upper surface (i.e., resin layer 4B) of carrier 4. Therefore, upper surface 81 of mask plate 8 maintains flatness.

In the next printing step, the squeegee operation is carried out. Cream solder 14, which is a paste for connecting electronic components to the circuit boards, is supplied on the upper surface of mask plate 8. As shown in FIG. 5C, squeegee member 13 is moved in a squeegee direction (shown by arrow C), while keeping contact between the lower end of squeegee member 13 and mask plate 8. Through the squeegee operation, pattern holes 10 are filled with cream solder 14 by squeegee member 13 As described earlier, only flat bottom 9A of recess 9 of mask plate 8 makes contact with the upper surface of circuit board 5 held by carrier 4, and lower surface 82 other than recesses 9 of mask plate 8 makes contact with the upper surface (i.e., resin layer 4B) of carrier 4. The close fitting condition eliminates the problem of heaved-up mask plate 8 caused by pressure of squeegee member 13 in the printing step.

On the completion of the printing step, the releasing step follows. In the releasing step, as shown in FIG. 5D, carrier 4 is moved down (in the direction shown by arrow D) by driving Zθ-axis table 2Z so that resin layer 4B is released from the lower surface of mask plate 8. Through the step, cream solder 14 set in pattern hole 10 is transferred or printed on each electrode 51 of circuit board 5. In this way, the screen printing operation for circuit boards 5 held by carrier 4 is completed.

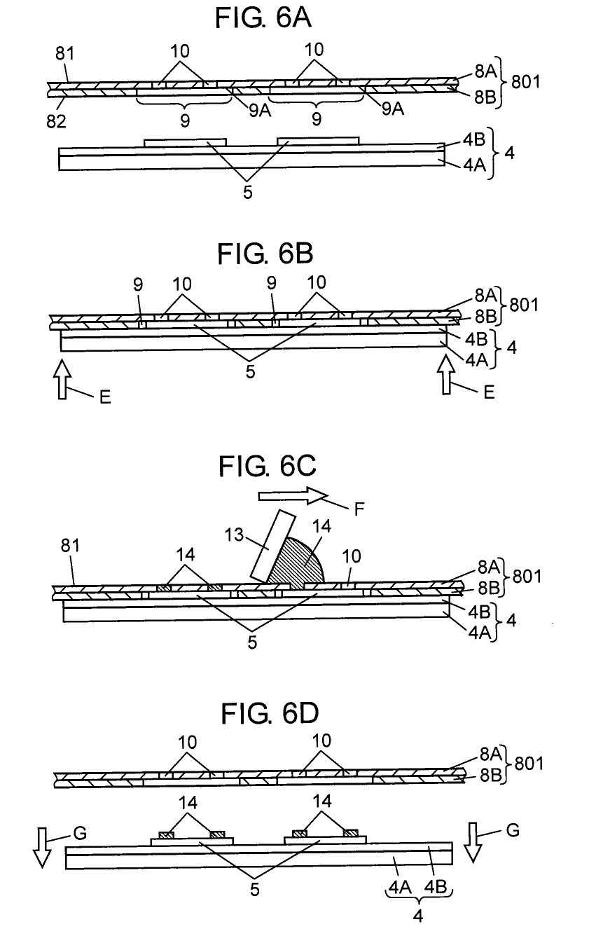

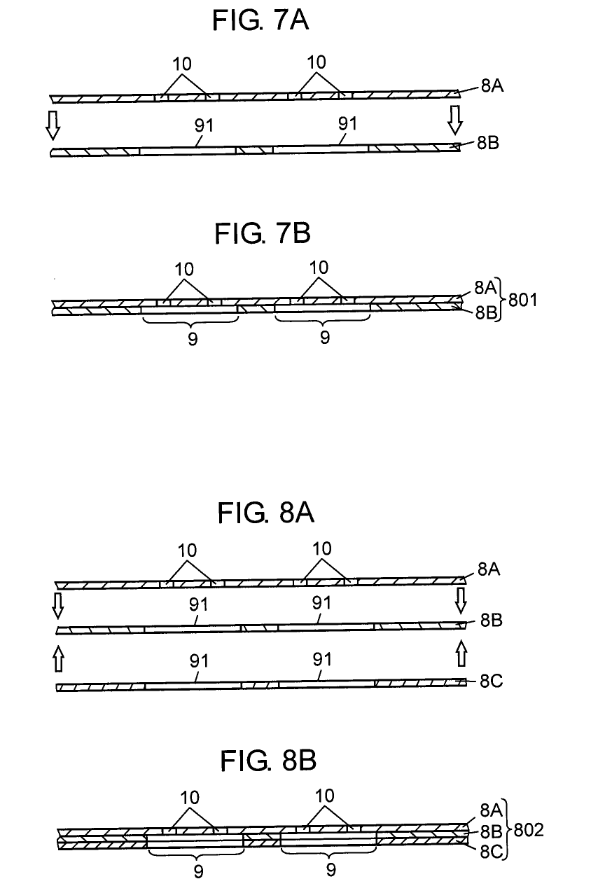

Although FIGS. 5A through 5D show an example where recesses 9 are formed on the lower surface of mask plate 8 by etching, recesses 9 are formed by a method other than etching. An example other than etching is described with reference to FIGS. 6A through 6D. FIGS. 6A through 6D illustrate printing operation of another screen printing device of the exemplary embodiment. FIG. 7A shows a sectional view of a screen printing mask, where the mask is divided into components, employed for the screen printing device shown in FIGS. 6A through 6D. FIG. 7B shows a sectional view of the screen printing mask employed for the screen printing device shown in FIGS. 6A through 6D.

The mask plate used in the example is not mask plate 8 formed of a single component but mask plate 801 formed of a layered structure. As shown in FIGS. 6A through 7B, mask plate 801 has plate layer 8A as a first plate layer and plate layer 8B as a second plate layer layered in the thickness direction. As shown in FIG. 7A, plate layer 8A is provided with pattern holes 10 used for printing, while plate layer 8B has opening 91 having a shape corresponding to that of recess 9. Opening 91 has a shape that defines the planar shape of recess 9.

Next, as shown in FIG. 7B, bonding plate layer 8A with plate layer 8B forms mask plate 801 that functions similar to mask plate 8 shown in FIGS. 5A through 5D. That is, mask plate 801 has a structure of plate layers 8A and 8B layered in the thickness direction of plate layer 8A. Plate layer 8A is provided with pattern holes 10, while plate layer 8B has opening 91 defining the planar shape of recess 9. On the lower surface of plate layer 8A, the area exposed from opening 91 of plate layer 8B serves as the flat bottom of recess 9.

Alternatively, mask plate 802 shown in FIGS. 8A and 8B may be used. FIG. 8A shows a sectional view of another mask for screen printing, where the mask is divided into components, employed for the screen printing device of the exemplary embodiment of the present invention. FIG. 8B shows a sectional view of another mask for screen printing employed for the screen printing device of the exemplary embodiment of the present invention. Mask plate 802 has a three-layer structure of plate layers 8A, 8B, and 8C.

Resin layer 4B of carrier 4 has an adhesion property. The adhesiveness can makes resin layer 4B to be attached firmly to the lower surface of the mask plate and hamper a normal release of carrier 4 in the releasing step. To obtain smooth release in this case, it is preferable to use mask plate 802 having a structure where plate layer 8C formed of PTFE resin or other non-adhesive resins is additionally disposed under plate layer 8B of mask plate 801 described earlier. ,

In other words, plate layer 8A has pattern holes 10, while plate layers 8B and 8C have openings 91 each of which defines the planer shape of recess 9. That is, plate layer 8A forms the first plate layer, and plate layers 8B and 8C form the second plate layer.

FIGS. 6A through 6D illustrate the screen printing operation on circuit boards 5 with use of mask plate 801 described above. In FIG. 6A, circuit boards 5 are held by the upper surface of resin layer 4B of carrier 4, just as with the example shown in FIG. 5A. In the positioning step, with the condition above maintained, carrier 4 is positioned by carrier positioning section 2 with respect to mask 7, which allows circuit boards 5 to be positioned with respect to recesses 9 on mask plate 801.

In the next touching step, as shown in FIG. 6B, carrier 4 is moved up (in the direction of arrow E) so that resin layer 4B makes contact with the lower surface of plate layer 8B. Through the process above, circuit board 5 is accommodated in recess 9 and electrodes 51 (see FIG. 3) to be printed thereon are located underneath corresponding pattern holes 10. At this time, only flat bottom 9A of recess 9 (i.e. the lower surface of plate layer 8A as the first plate layer) makes contact with the upper surface of circuit board 5 held by carrier 4. At the same time, lower surface 82 of mask plate 801 except for recesses 9 (i.e. the lower surface of plate layer 8B as the second plate layer) makes contact with upper surface of carrier 4(i.e., resin layer 4B), allowing upper surface 81 of mask plate 801 (i.e. the upper surface of plate layer 8A as the first plate layer) to maintain flatness.

In the next printing step, the squeegee operation is carried out. Cream solder 14, which is a paste for connecting electronic components to the circuit boards, is supplied on the upper surface of plate layer 8A. As shown in FIG. 6C, squeegee member 13 is moved in a squeegee direction (shown by arrow F), while keeping contact between the lower end of squeegee member 13 and plate layer 8A. As described earlier, only flat bottom 9A of recess 9 of mask plate 801 makes contact with the upper surface of circuit board 5 held by carrier 4, and lower surface 82 other than recesses 9 of mask plate 801 makes contact with the upper surface (i.e., resin layer 4B) of carrier 4. The close fitting condition eliminates the problem of heaved-up mask plate 801 caused by pressure of squeegee member 13 in the printing step.

Through the squeegee operation, pattern holes 10 are filled with cream solder 14 by squeegee member 13. On the completion of the printing step, the releasing step follows. In the releasing step, as shown in FIG. 6D, carrier 4 is moved down (in the direction shown by arrow G) by driving Zθ-axis table 2Z so that resin layer 4B is released from the lower surface of plate layer 8B. Through the step, as with the example shown in FIG. 5D, cream solder 14 set in pattern hole 10 is printed on each electrode 51 of circuit board 5. In this way, the screen printing operation for circuit boards 5 held by carrier 4 is completed.

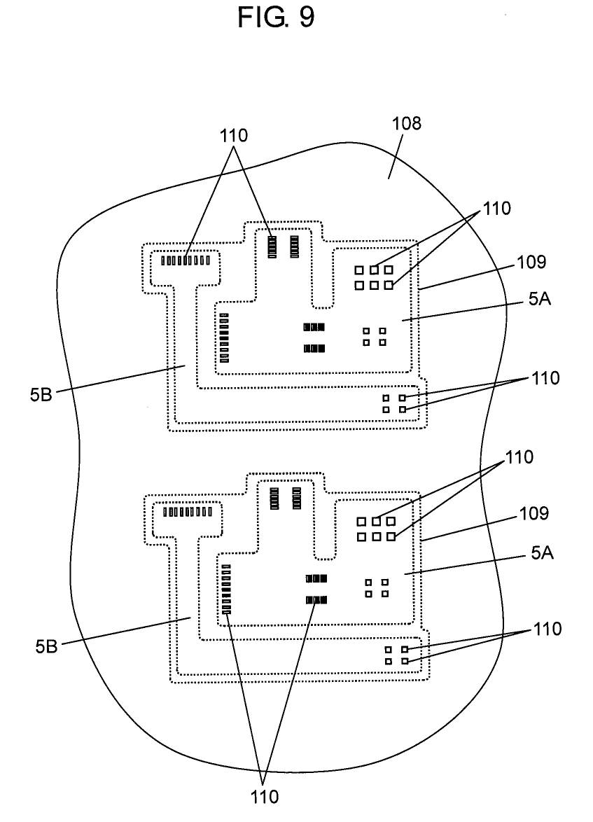

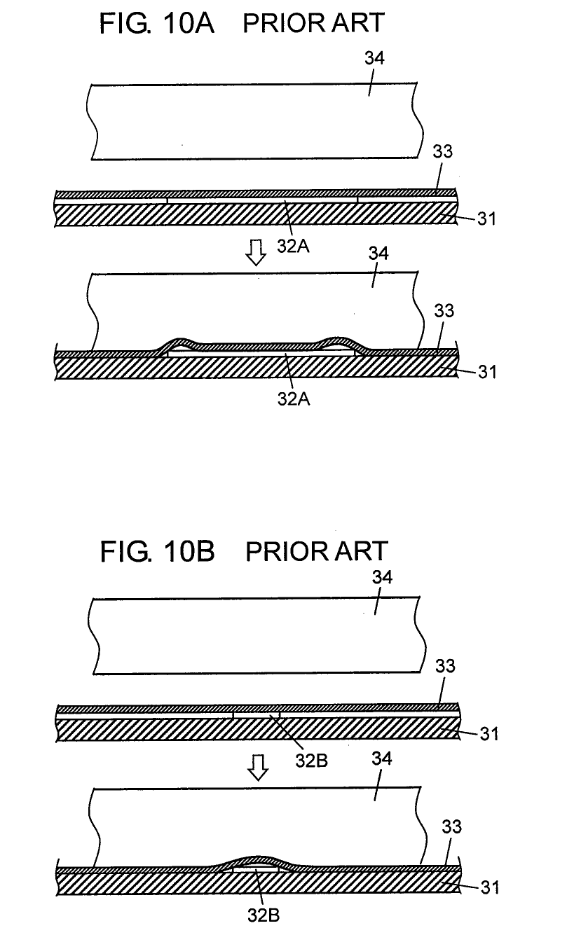

According to mask plates 8, 801, and 802 shown in FIGS. 4 through 8B, each recess 9 is formed for accommodating single circuit board 5, however, it is not limited to the structure; two-or-more circuit boards 5 may be accommodated in single recess 9. Such an example will be described with reference to FIG. 9. FIG. 9 is a perspective plan view of still another mask for screen printing employed for the screen printing device of the exemplary embodiment of the present invention.

Recess 109 of mask plate 108 has a planer shape that conforms to the external shape of a combination of circuit board 5A and 5B. In recess 109, pattern holes 110 are provided so as to meets with electrodes formed on circuit boards 5A and 5B. Circuit boards 5A and 5B are disposed on carrier 4 so as to be in the right place of the combined shape.

As is described in the examples above, mask 7 for screen printing used in the exemplary embodiment has a flat mask plate. On the lower surface of each mask plate, recesses are formed so as to be positioned to circuit boards arrayed in carrier 4. Each of the recess accommodates at least one of the circuit boards. A pattern hole is formed only in the recess so as to correspond to an electrode.

The structure above allows even simply formed carrier 4 with a flat adhesive holding surface to prevent printing failure caused by difference in height between the flat adhesive holding surface of carrier 4 and the surface to be printed, of circuit board 5. Further, circuit boards 5 of different types and shapes can be mounted together on single carrier 4, which contributes to significant decrease in necessary quantity of carrier 4. In other words, high printing quality at a low cost can be achieved in printing operation on circuit boards 5 held by carrier 4.

### INDUSTRIAL APPLICABILITY

The screen printing device and the mask for screen printing of the present invention achieve high printing quality at a low cost in printing operation on circuit boards held by a carrier. The present invention is therefore useful when paste, which is to be used for connecting electronic components to the circuit boards, is printed on the circuit boards held by the carrier.

1. A screen printing device configured to simultaneously print paste, which is to be used for connecting electronic components to circuit boards, on an electrode formed on each of the circuit boards arrayed and held by a carrier, the device comprising:
a printing mechanism including:
a single mask for screen printing having a flat mask plate that covers an area where the circuit boards are arrayed on the carrier; and
a squeegee member; and
a carrier positioning section configured to position the carrier so that the circuit boards are positioned with respect to the mask,
wherein the printing mechanism is configured to print the paste on the electrode by squeegee operation in which the squeegee member is slid on a paste-applied upper surface of the mask, and
wherein a recess having a flat part capable of accommodating at least one of the circuit boards is formed on a lower surface of the mask plate so as to correspond to the array of the circuit boards fixed on the carrier, and a pattern hole corresponding to the electrode is formed only in the recess.

2. The screen printing device according to claim 1, wherein the recess has a flat bottom, only the flat bottom makes contact with an upper surface of at least one of the circuit boards fixed on the carrier, and the lower surface other than the recess of the mask plate makes contact with an upper surface of the carrier.

3. The screen printing device according to claim 2, wherein the mask plate has a first plate layer and a second plate layer layered in a thickness direction of the first plate layer, the first plate layer has the pattern hole and the second plate layer has an opening that defines the flat part of the recess, and an area exposed from the opening of the second plate layer on a lower surface of the first plate layer forms the flat bottom of the recess.

4. A screen printing mask used for simultaneously printing paste, which is to be used for connecting electronic components to circuit boards, on an electrode formed on each of the circuit boards are arrayed and held by a carrier, the mask comprising:
a flat mask plate that covers an area where the circuit boards are arrayed on the carrier,
wherein a recess having a flat part capable of accommodating at least one of the circuit boards is formed on a lower surface of the mask plate so as to correspond to the array of the circuit boards held by the carrier, and a pattern hole corresponding to the electrode is formed only in the recess.

5. The screen printing mask according to claim 4, wherein the recess has a flat bottom, only the flat bottom makes contact with an upper surface of at least one of the circuit boards held by the carrier, and the lower surface other than the recess of the mask plate makes contact with an upper surface of the carrier.

6. The screen printing mask according to claim 5, wherein the mask plate has a first plate layer and a second plate layer layered in a thickness direction of the first plate layer, the first plate layer has the pattern hole and the second plate layer has an opening that defines the flat part of the recess, and an area exposed from the opening of the second plate layer on a lower surface of the first plate layer forms the flat bottom of the recess.

7. A method of screen printing, with use of a screen printing mask having a pattern hole therein, for simultaneously printing paste, which is to be used for connecting electronic components to circuit boards, on an electrode formed on each of the circuit boards arrayed and held by a carrier,
wherein the mask has a flat mask plate, a recess having a flat part capable of accommodating at least one of the circuit boards is formed on a lower surface of the mask plate so as to correspond to the array of the circuit boards held by the carrier, and a pattern hole corresponding to the electrode is formed only in the recess,
the method comprising:
positioning the screen printing mask with respect to the circuit boards held by the carrier in a manner that the recess covers at least one of the circuit boards;
touching the mask positioned in the positioning to an upper surface of the carrier and upper surfaces of the circuit boards held by the carrier;
printing by filling the paste supplied on the mask into the pattern hole by squeegee operation in which a squeegee member is slid on a paste-applied upper surface of the mask, while the mask is being touched to an upper surface of the carrier; and
releasing the mask from the carrier and the circuit boards.

8. The method of screen printing according to claim 7, wherein the recess has a flat bottom, and in the filling, only the flat bottom makes contact with an upper surface of at least one of the circuit boards held by the carrier, and the lower surface other than the recess of the mask plate makes contact with an upper surface of the carrier.

9. The method of screen printing according to claim 8, wherein the mask plate has a first plate layer and a second plate layer layered in a thickness direction of the first plate layer, the first plate layer has the pattern hole and the second plate layer has an opening that defines the flat part of the recess, and an area exposed from the opening of the second plate layer on a lower surface of the first plate layer forms the flat bottom of the recess.
